(19) United States
(12) Patent Application Publication
(10) Pub. No.: US 2009/0195393 A1
(43) Pub. Date: Aug. 6, 2009

(54) PET DOOR MAT SYSTEM WITH PROXIMITY INDICATOR

(76) Inventor: Alan Tegeler, Hope, ME (US)

Correspondence Address: SCHUBERT OSTERRIEDER & NICKELSON PLLC, 6013 CANNON MTN DR, S14, AUSTIN, TX, 78749, US

(21) Appl. No.: 12/023,256

(22) Filed: Jan. 31, 2008

(51) Int. Cl. G08B 21/00

(52) U.S. Cl. 340/573.3; 340/686.1

(57) ABSTRACT

Systems and apparatuses for providing a pet pressure mat and proximity indicator to provide a notification to a pet owner when a pet is near a door are disclosed. The proximity indicator, in response to a signal from the mat, provides an indication of the pet being positioned on the mat. The mat may include a power source, a bottom exterior layer, and a top exterior layer attached to the bottom layer to substantially enclose the mat. A single layer of dielectric spacer having one or more openings may be positioned between the top layer and the bottom layer. Two conductive foil sheets may be separated when no external compressive force exists and may contact each other within an opening of the spacer when a sufficient external compressive force is applied to the mat. A signal is generated when the two conductive foil sheets contact each other.

### FIELD OF INVENTION

Embodiments are in the field of pressure-activated doormats. More particularly, embodiments are in the field of pressure-activated doormats that activate a notification signal when an animal steps on the doormat.

### BACKGROUND

Pet owners often allow their pets to spend time both inside the owner's house as well as outside. Ingress and egress by pets often causes frustration for pet owners as a pet may desire to go through the door and be unable to communicate that desire to their owners. In these situations, a pet may stand or lie near the door and simply wait for the owner to notice their situation, resulting in an unsatisfactory situation for the pets and possibly resulting in accidents or frustration. Other pets may scratch the door to indicate that they desire to go through it. This solution may provide notice to the owner depending on the layout of the owner's house, but repeated scratching may cause damage to the door. Other owners may avoid the problem entirely by placing a pet door within the door to the outside of the house so that the animal may pass through freely, but such a solution is often expensive, has safety concerns (particularly with pet doors large enough for a large dog), potentially results in increased heating or cooling costs, and often results in the owner not knowing the current location of their pet.

Previous systems disclose a solution with a pressure-sensitive mat that triggers an alarm when a pet steps on it. These previous systems, however, are complex and thus expensive, limiting their commercial viability. Moreover, these previous systems are limited in flexibility and capability. Enhancements to pressure-sensitive mat systems for notifying owners when a pet is near a door may thus prove useful and desirable.

### SUMMARY OF THE INVENTION

The problems identified above are in large part addressed by systems and apparatuses for providing a pet pressure mat and proximity indicator to provide a notification to a pet owner when a pet is near a door. A pet doormat system with a proximity indicator and a pet pressure mat in communication with the proximity indicator is disclosed. The proximity indicator may, in response to receipt of a signal from the pet pressure mat, provide an indication of the pet being positioned on the mat. Embodiments of the pet pressure mat may include a power source, a bottom exterior layer, and a top exterior layer where the top exterior layer is attached to the bottom exterior layer to substantially enclose components of the pet pressure mat and where the top exterior layer has a mat top surface to receive an external compressive force resulting from an animal stepping on the pressure mat. Embodiments may also include a single layer of dielectric spacer having one or more openings and being positioned between the top exterior layer and the bottom exterior layer and substantially parallel to the two exterior layers. Embodiments may also include two conductive foil sheets electrically connected to the power source and positioned on opposite sides of and substantially parallel to the single layer of dielectric spacer such that the two conductive foil sheets are separated when no external compressive force on the pet pressure mat exists. The two conductive foil sheets may contact each other within one or more openings of the single layer of dielectric spacer when a sufficient external compressive force is applied to the pet pressure mat and a signal indicating that the pet is positioned on the pet pressure mat is generated when the two conductive foil sheets contact each other.

A pet pressure mat apparatus is also disclosed. Embodiments of the pet pressure mat apparatus may include a power source, a wireless transmitter to wireless transmit generated signals to a proximity indicator, a bottom exterior layer, and a top exterior layer. The top exterior layer is attached to the bottom exterior layer to substantially enclose components of the pet pressure mat and the top exterior layer has a mat top surface to receive an external compressive force resulting from an animal stepping on the pressure mat. Embodiments may also include a single layer of dielectric spacer having one or more openings and being positioned between the top exterior layer and the bottom exterior layer and substantially parallel to the two exterior layers. Embodiments may also include two conductive foil sheets electrically connected to the power source and positioned on opposite sides of and substantially parallel to the single layer of dielectric spacer such that the two conductive foil sheets are separated when no external compressive force on the pet pressure mat exists. The two conductive foil sheets may contact each other within one or more openings of the single layer of dielectric spacer when a sufficient external compressive force is applied to the pet pressure mat and a signal indicating that the pet is positioned on the pet pressure mat is generated when the two conductive foil sheets contact each other and transmitted via the wireless transmitter.

### BRIEF DESCRIPTION OF THE DRAWINGS

Aspects of various embodiments will become apparent upon reading the following detailed description and upon reference to the accompanying drawings in which like references may indicate similar elements:

FIG. 1 depicts schematic views of a pet door mat system with a pet pressure mat and proximity indicator according to various embodiments;

FIG. 2 depicts a side exploded view of different layers of the pet pressure mat according to various embodiments;

FIG. 3 depicts a top partial exploded view of different layers of the pet pressure mat according to various embodiments;

FIG. 4 depicts a side partial cut-away view of a deflected foil sheet of the pet pressure mat according to various embodiments;

FIG. 5 depicts a top view of a single layer of dielectric space of the pet pressure mat according to various embodiments; and

FIG. 6 depicts a side partial cut-away view of a pet pressure mat edge according to various embodiments.

### DETAILED DESCRIPTION OF EMBODIMENTS

The following is a detailed description of embodiments of the invention depicted in the accompanying drawings. The embodiments are introduced in such detail as to clearly communicate the invention. However, the embodiment(s) presented herein are merely illustrative, and are not intended to limit the anticipated variations of such embodiments; on the contrary, the intention is to cover all modifications, equivalents, and alternatives falling within the spirit and scope of the appended claims.

Various embodiments of the present invention provide systems and apparatuses for providing pressure-activated doormats that activate a notification signal when an animal steps on the doormat. The following description provides specific details of certain embodiments of the invention illustrated in the drawings to provide a thorough understanding of those embodiments. It should be recognized, however, that the present invention can be reflected in additional embodiments and may be practiced without some of the details in the following description. In other instances, well-known structures and functions have not been shown or described in detail to avoid unnecessarily obscuring the description of the embodiments. While specific embodiments will be described below with reference to particular configurations and systems, those of skill in the art will realize that the disclosed embodiments may advantageously be implemented with other substantially equivalent configurations and/or systems.

Generally speaking, systems and apparatuses for providing a pet pressure mat and proximity indicator to provide a notification to a pet owner when a pet is near a door are disclosed. Embodiments of the proximity indicator, in response to a signal from the mat, provide an indication of the pet being positioned on the mat. The mat may include a power source, a bottom exterior layer, and a top exterior layer attached to the bottom layer to substantially enclose the mat. A single layer of dielectric spacer having one or more openings may be positioned between the top layer and the bottom layer according to some embodiments. Two conductive foil sheets may be separated when no external compressive force exists and may contact each other within an opening of the spacer when a sufficient external compressive force is applied to the mat according to some embodiments. A signal is generated when the two conductive foil sheets contact each other according to some embodiments.

The disclosed systems and apparatuses may provide for an effective, efficient, and flexible pressure-sensitive doormat for providing notification that a pet or other animal is near a door. As will be described in more detail subsequently, the disclosed system provides for a pet door mat system with a proximity indicator and a multi-layer pet pressure mat. The pet pressure mat includes a dielectric spacer with one or more openings that may be customized in size, number, and shape to configure the pet pressure mat to be sensitive to pets of different sizes and weights. The disclosed embodiments also facilitate the use of relatively inexpensive materials and a straightforward design to assist in lowering the price of manufacture while retaining effectiveness. The disclosed embodiments also provide for either wired or wireless connections between the pet pressure mat and the proximity indicator, as well as a wide variety of proximity indicators such as audible alarms, visual alarms, or other types of indicators.

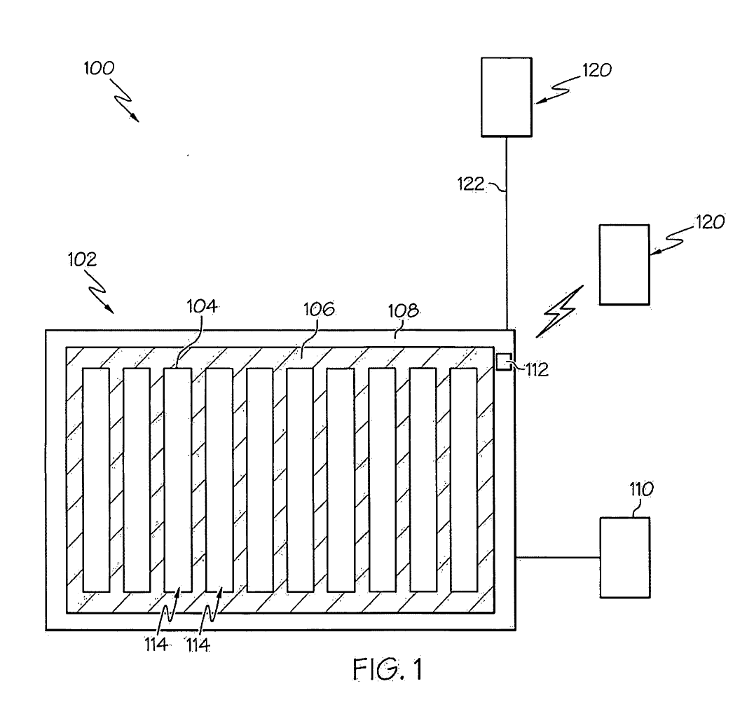

FIG. 1 depicts schematic views of a pet doormat system with a pet pressure mat and proximity indicator according to various embodiments. The pet doormat system 100 of FIG. 1 includes a pet pressure mat 102, a power source 110 for the pet pressure mat 102, and a proximity indicator 120. The pet pressure mat 102 and proximity indicator 120 may be in communication via either a wired or wireless connection so that the pet pressure mat 102 may transmit indications that a pet or other animal is positioned on the pet pressure mat 102 and so the proximity indicator may provide an alert or other indication to a user, such as the pet owner. As will be described in more detail subsequently, the disclosed pet doormat system 100 may thus allow a pet owner to place a pet pressure mat 102 in front of a door in their house and be alerted when a pet stands on the pet pressure mat 102. Many pets will quickly learn that by standing on the pet pressure met 102 or in front of a door that the pet owner will arrive to open the door for them, making the disclosed system effective at informing pet owners that their pet wishes to ingress or egress.

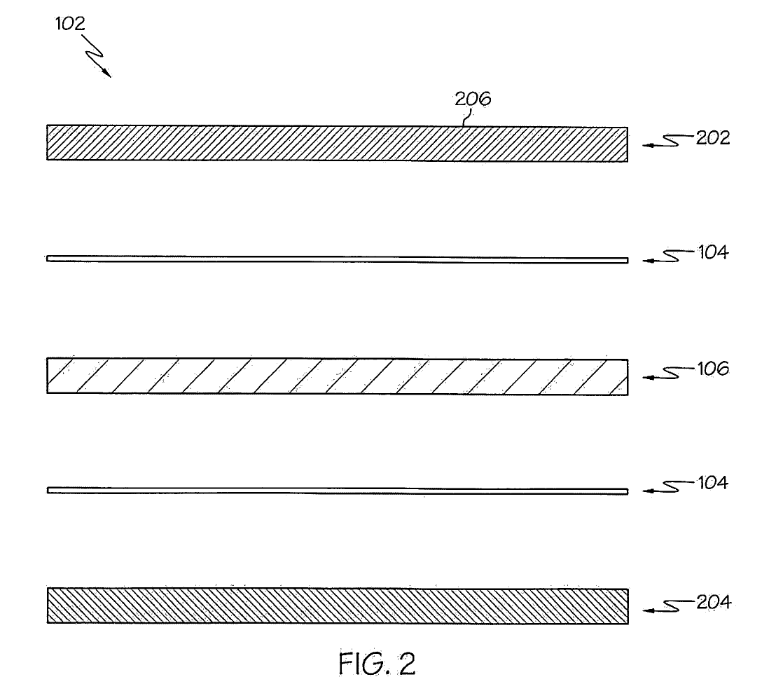

The pet pressure mat 102 is depicted in FIG. 1 with a top, cut-away view and includes a foil sheet 104, a dielectric spacer 106 with a plurality of openings 114, and an exterior layer 108. The pet pressure mat 102 may typically include five layers (as described more fully in relation to FIG. 2) and the top two layers are not shown in the cut-away view of FIG. 1 in the interest of clarity. An upper foil sheet (not shown in FIG. 1) will deflect through one of the openings 114 in the dielectric spacer 106 in response to a pet foot (or any other compressive force) stepping on the pet pressure mat 102. If the compressive force is sufficient, the two foil sheets 104 will contact each other and close an electrical circuit as each foil sheet 104 is conductive and subject to an electrical charge from the power source 110.

Power source 110 may be any source of power adapted to apply a charge to the foil sheets 104. In a typical embodiment, power source 110 may be a battery (or multiple batteries) that supplies a DC current when the two foil sheets 104 touch. In other embodiments, power source 110 may be an electrical outlet plug that is adapted to plug in to a household electrical outlet (possibly also with an AC/DC converter). In yet another embodiment, the power source 110 may include a solar panel for generation and a capacitor for storage of energy. One of ordinary skill in the art will recognize that any type of power source sufficient to apply a charge to at least one of the foil sheets 104 may be used as power source 110.

Once the two foil sheets 104 contact each other and an electrical circuit is closed, a signal is generated indication that the foil sheets 104 are in contact and that a pet is positioned on the pet pressure mat 102. In some embodiments, the proximity indicator 120 may be connected with the pet pressure mat 102 via a wire 122 that receives the signal from the foil sheets 104 via the wire 122. Wire 122 may be any type of conductive wire or may alternatively be a fiber optic or other type of wire. In these embodiments, the proximity indicator 120 may treat the signal from the foil sheets as a binary signal where a measurable voltage indicates the foil sheets 104 are in contact and no measurable voltage indicates that the foil sheets 104 remain separated.

In other embodiments, a transmitter 112 may wirelessly transmit an indication that the foil sheets 104 are in contact to a proximity indicator 120 (which itself would have a wireless receiver in this embodiment). Any type of transmitter may be used that is sufficient to transmit a signal a desired distance between the proximity indicator 120 and pet pressure mat 102, including radio transmitters, radio frequency identification (RFID) transmitters, Bluetooth transmitters, cellular transmitters, etc. While the embodiment of FIG. 1 depicts both a wire 122 and a transmitter 112 for communication with proximity indicators 120, both types of connection are not required and other types of communication methodologies may also instead be used.

The proximity indicator 120 may be any type of device that receives a signal from the pet pressure mat 102 and provides an indication of a pet being positioned on the pet pressure mat 102 to a user. As described previously, the proximity indicator 120 may receive the signal from the pet pressure mat 102 via a wire, via a wireless connection (with a wireless-equipped proximity indicator 120), or via other means. The proximity indicator 120 may provide any type of indications to users. In some embodiments, the proximity indicator 120 may provide audible indications, such as by having a speaker or other sound source that can generate “doorbell” sounds, buzzing sounds, recorded messages (e.g., “The dog is at the back door”), or any other sound. In other embodiments, the proximity indicator 120 may provide visible indications that a pet is standing on the pet pressure mat 102, such as by a light source that is visible by users when turned on or that generates a text message or other visual message.

In yet other embodiments, the proximity indicator 120 may be a device that includes other functions in addition to notification of a pet standing on the pet pressure mat 102. The proximity indicator 120 may be, for example, a home personal computer or home security system that provides an appropriate message to users. A pet owner working on their computer may, in this example, receive a “pop up” message on their screen notifying them of the pet at the door. The personal computer itself may serve as the proximity indicator 120 (e.g., such as via a Bluetooth receiver) or a separate repeater station may also serve as part of the proximity indicator 120. In yet another example, the proximity indicator 120 may be a pager, wireless phone, or other handheld wireless device that may provide notifications to users via vibration, audio alarm, visual notification, etc. One of ordinary skill in the art will recognize that any type or combination of proximity indicators 120 may be used, such as by combining a light and sound source or a sound source with a text message to a wireless phone.

Different combinations of pet pressure mats 102 and proximity indicators 120 may also be used. Multiple proximity indicators 120 may provide notifications from a single pet pressure mat 102, which may prove useful for users who desire to have proximity indicators 120 at different locations through the house (as well as different types of proximity indicators 120). Similarly, a single proximity indicator 120 may provide notifications for multiple pet pressure mats 102. This may prove useful, for example, when a pet owner places a pet pressure mat 102 on both sides of a door so that they will know both when a pet desires to go outside and come inside. In this example, different indications may be used for signals from different pet pressure mats 102, such as by having different sounds for each pet pressure mat 102. Multiple proximity indicators 120 may also serve multiple pet pressure mats 102 according to other embodiments, providing a flexible arrangement for larger houses.

FIG. 2 depicts a side exploded view of different layers of the pet pressure mat 102 according to various embodiments. The pet pressure mat 102 of FIG. 2 includes (from top to bottom) a top exterior layer 202, a foil sheet 104, a dielectric spacer 106, a second foil sheet 104, and a bottom exterior layer 204. The top exterior layer 202 may be attached to the bottom exterior layer 204 to substantially enclose the other components of the pet pressure mat 102. The top exterior layer 202 may have a mat top surface 206 to receive an external compressive force resulting from, for example, an animal stepping on the pet pressure mat 102. In some embodiments, both of the top exterior layer 202 and the bottom exterior layer 204 may be constructed of a substantially waterproof material to assist in protecting the pet pressure mat 102 from rain or other moisture. Waterproofing may be particularly useful when the pet pressure mat 102 is intended to be used outside and therefore exposed to the elements. The top exterior layer 202 may, in some embodiments, be comprised of a carpet with waterproof backing to assist it in performing as a typical doormat in addition to its pet notification functions. Similarly, the bottom exterior layer 204 may advantageously be comprised of a tough and waterproof material such as rubber that also provides significant frictional resistance to movement to help prevent slippage.

As described previously, each of the foil sheets 104 may be comprised of any type of conductive material and one or both may be electrically connected to the power source 110. The foil sheets 104 may be constructed of a flexible, conductive material such as an aluminum foil or similar material according to some embodiments. Each foil sheet 104 may also be a full sheet that covers substantially the area of the pet pressure mat 102 to assist in construction and assembly, or it may only cover area corresponding to the openings in the dielectric sheet 106 according to alternative embodiments. The conductive foil sheets 104 may be substantially parallel to the single layer of dielectric spacer 106 such that the two conductive foil sheets 104 are separated when no external compressive force on the pet pressure mat 102 exists. When a compressive force is applied to the pet pressure mat 102, the top exterior layer 202 and top foil sheet 104 may both be compressed and deflected downward and, if the compressive force is sufficient to complete the contact, the two foil sheets 104 may contact each other within one or more openings in the single layer of dielectric spacer 106 to complete the electrical circuit and initiate a signal.

The single layer of dielectric spacer 106 positioned between the two foil sheets 104 may be comprised of any type of dielectric or substantially non-conductive material such as a foam material. The single layer of dielectric spacer 106 may be positioned substantially parallel to the two exterior layers. A material such as foam that is both deflectable and resilient may be useful for the single layer of dielectric spacer 106 as the compression of the dielectric spacer 106 will facilitate contact of the two foil sheets 104 and the resiliency of the material will allow the pet pressure mat 102 to return to its original shape. As described previously, the single layer of dielectric spacer 106 has one or more openings 114 (not show in FIG. 2) to allow for the two foil sheets 104 to contact each other.

The number, shape, size, and configuration of the openings 114 may be a design decision based on the materials used and the anticipated pet paw sizes and weights. A pet pressure mat 102 designed for larger dogs, for example, may have larger openings 114 and a thicker dielectric spacer 106 according to some embodiments so that other animals (e.g., a neighborhood stray cat) do not cause false alarms. Different dielectric spacers 106 may be assembled so that they are permanently part of a pet pressure mat 102, resulting in different pet pressure mats 102 designed for different types of animals to be sold. In other embodiments, the dielectric spacer 106 may be user-replaced so that customized or non-standard pet pressure mats 102 may be purchased and installed as accessories.

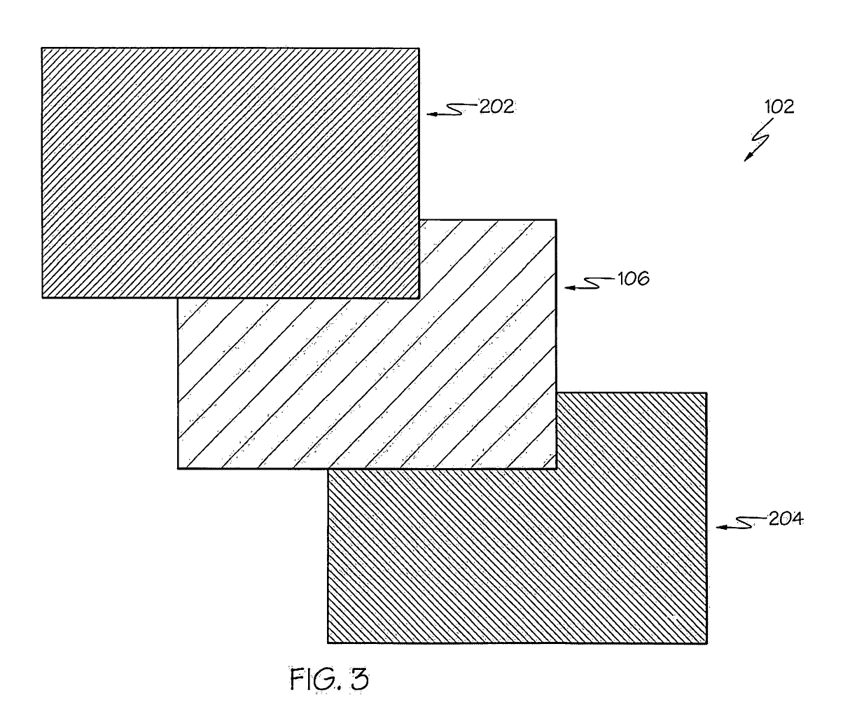

FIG. 3 depicts a top partial exploded view of different layers of the pet pressure mat 102 according to various embodiments. The pet pressure mat 102 of FIG. 3 illustrates one corner of a rectangular pet pressure mat 102 including a top exterior layer 202, a dielectric spacer 106, and a bottom exterior layer 204. The foil sheets 104 are not shown in the interest of clarity and they need not cover the area described in FIG. 3 as no openings 114 in the dielectric spacer 106 are shown.

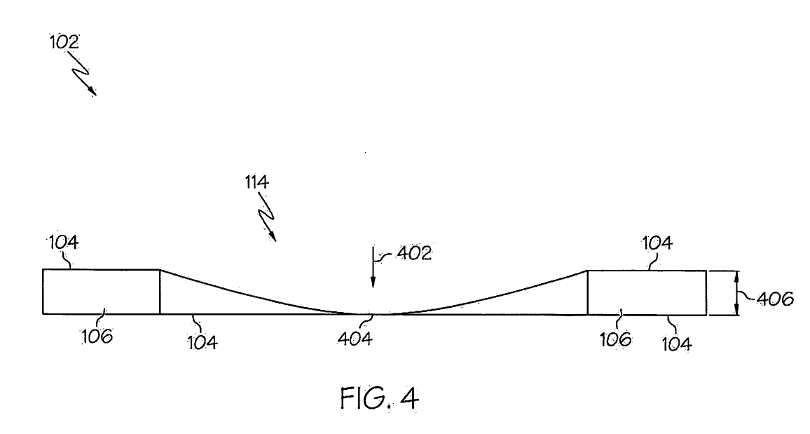

FIG. 4 depicts a side partial cut-away view of a deflected foil sheet 104 of the pet pressure mat 102 according to various embodiments. In the pet pressure mat 102 of FIG. 4, the position of foil sheets 104 within an opening 114 in the dielectric spacer 106 during operation is illustrated. The dielectric spacer 106 may have a thickness 406 when no external compressive force is applied. When an external compressive force 402 is applied (resulting from the weight of a pet as translated through a paw and the top exterior layer, which are not shown), the top foil sheet 104 deflects downward in the amount of the dielectric space thickness 406 due to the compressive force. The top exterior layer 202 that is not shown may also similarly deflect downward. If sufficient force is applied, the two foil sheets contact at a contact point 404, complete a circuit, and generate a signal which itself is turned into an indication that the pet is standing on the pet pressure mat 102. Compression of the dielectric spacer 106 itself is not shown in FIG. 4 in the interest of clarity, but to the extent that it also compresses the amount of deflection of the top foil sheet 104 is reduced.

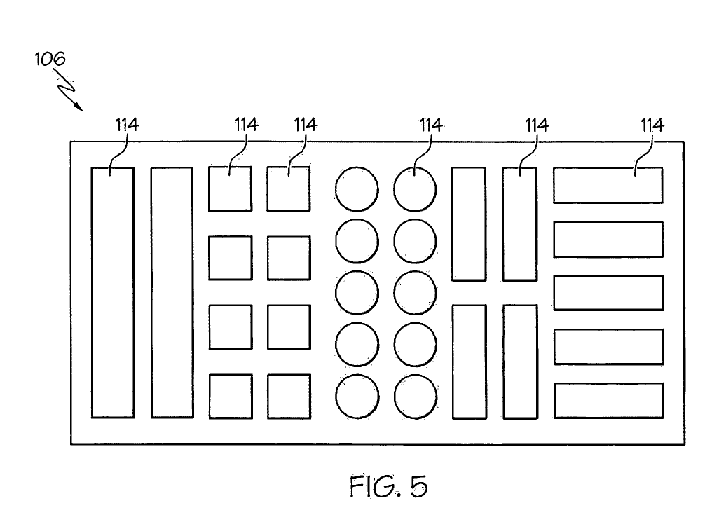

FIG. 5 depicts a top view of a single layer of dielectric space 106 of the pet pressure mat 102 according to various embodiments. The dielectric spacer 106 of FIG. 5 has a wide variety of shapes and sizes of openings 114, including rectangular (including horizontal and vertical), square, and circular openings. A configuration as depicted in FIG. 5 is unlikely to be used in a commercial product but helps illustrate the flexibility of the size, shape, number, and configuration of openings 114 possible. As described previously, the particular configuration and design of the openings 114 may be optimized based on manufacturing constraints, cost, anticipated pet sizes, or other factors.

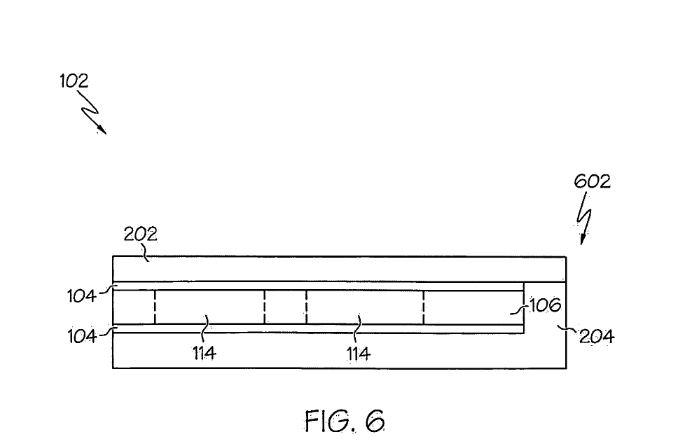

FIG. 6 depicts a side partial cut-away view of a pet pressure mat 102 edge according to various embodiments. In the embodiment of FIG. 6, the bottom exterior layer 204 extends upwards to form a seal with the top exterior layer 202 at the pressure mat edge 602. The two foil sheets 104 and the dielectric spacer 106 may thus be located within the volume that is substantially enclosed by the top exterior layer 202 and the bottom exterior layer 204. One of ordinary skill in the art will recognize that other configurations are possible, including the top exterior layer wrapping downwards, the foil sheets and/or dielectric spacer 106 extending to the pressure mat edge 602, or both the bottom exterior layer 204 and top exterior layer wrapping around to meet at a point in between.

While certain operations have been described herein relative to a direction such as “above” or “below” it will be understood that the descriptors are relative and that they may be reversed or otherwise changed if the relevant structure(s) were inverted or moved. Therefore, these terms are not intended to be limiting.

It will be apparent to those skilled in the art having the benefit of this disclosure that the present invention contemplates systems and apparatuses for providing a pet pressure mat 102 and proximity indicator 120 to provide a notification to a pet owner when a pet is near a door. It is understood that the form of the invention shown and described in the detailed description and the drawings are to be taken merely as examples. Although the present invention and some of its advantages have been described in detail for some embodiments, it should be understood that various changes, substitutions and alterations can be made herein without departing from the spirit and scope of the invention as defined by the appended claims. Accordingly the inventive embodiments are not limited by the specific disclosure above, but rather should be limited only by the scope of the appended claims and their legal equivalents. It is intended that the following claims be interpreted broadly to embrace all the variations of the example embodiments disclosed.

Although an embodiment may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A pet doormat system, comprising:
a proximity indicator to provide, in response to receipt of a signal from a pet pressure mat, an indication of a pet being positioned on the pet pressure mat; and
a pet pressure mat in communication with the proximity indicator, comprising:
a power source;
a bottom exterior layer;
a top exterior layer attached to the bottom exterior layer to substantially enclose components of the pet pressure mat, the top exterior layer having a mat top surface to receive an external compressive force resulting from an animal stepping on the pet pressure mat;
a single layer of dielectric spacer having one or more openings and being positioned between the top exterior layer and the bottom exterior layer and substantially parallel to the two exterior layers;
two conductive foil sheets electrically connected to the power source and positioned on opposite sides of and substantially parallel to the single layer of dielectric spacer such that the two conductive foil sheets are separated when no external compressive force on the pet pressure mat exists;
wherein the two conductive foil sheets contact each other within one or more openings of the single layer of dielectric spacer when a sufficient external compressive force is applied to the pet pressure mat; and
wherein a signal indicating that a pet is positioned on the pet pressure mat is generated when the two conductive foil sheets contact each other.

2. The system of claim 1, wherein the pet pressure mat further comprises a wireless transmitter to transmit generated signals to the proximity indicator, and wherein further the proximity indicator further comprises a wireless receiver for receiving wireless signals.

3. The system of claim 1, wherein the proximity indicator and pet pressure mat are in communication via a wire.

4. The system of claim 1, wherein the proximity indicator comprises a sound source to provide an audible signal that a pet is positioned on the pet pressure mat.

5. The system of claim 1, wherein the proximity indicator comprises a light source to provide a visible signal that a pet is positioned on the pet pressure mat.

6. The system of claim 1, wherein the power source of the pet pressure mat comprises one or more batteries.

7. The system of claim 1, wherein the power source of the pet pressure mat comprises an electrical outlet plug adapted to plug in to a household electrical outlet.

8. The system of claim 1, wherein the bottom exterior layer and the top exterior layer each comprise a substantially waterproof material.

9. The system of claim 1, wherein the single layer of dielectric spacer comprises a layer of foam.

10. The system of claim 1, wherein the plurality of openings in the single layer of dielectric spacer comprise a plurality of rectangular openings.

11. The system of claim 1, wherein the plurality of openings in the single layer of dielectric spacer comprise a plurality of circular openings.

12. The system of claim 1, wherein the two conductive foil sheets each comprise an aluminum foil.

13. The system of claim 1, wherein the signal indicating that a pet is positioned on the pet pressure mat is only generated after the two conductive foil sheets contact each other for at least a pre-defined period of time.

14. A pet pressure mat apparatus, comprising:
a power source;
a wireless transmitter to wirelessly transmit generated signals to a proximity indicator;
a bottom exterior layer;
a top exterior layer attached to the bottom exterior layer to substantially enclose components of the pet pressure mat, the top exterior layer having a mat top surface to receive an external compressive force resulting from an animal stepping on the pet pressure mat;
a single layer of dielectric spacer having one or more openings and being positioned between the top exterior layer and the bottom exterior layer and substantially parallel to the two exterior layers;
two conductive foil sheets electrically connected to the power source and positioned on opposite sides of and substantially parallel to the single layer of dielectric spacer such that the two conductive foil sheets are separated when no external compressive force on the pet pressure mat exists;
wherein the two conductive foil sheets contact each other within one or more openings of the single layer of dielectric spacer when a sufficient external compressive force is applied to the pet pressure mat; and
wherein a signal indicating that a pet is positioned on the pet pressure mat is generated when the two conductive foil sheets contact each other and transmitted via the wireless transmitter.

15. The apparatus of claim 1, wherein the power source comprises one or more batteries.

16. The apparatus of claim 1, wherein the power source comprises an electrical outlet plug adapted to plug in to a household electrical outlet.

17. The apparatus of claim 1, wherein the bottom exterior layer and the top exterior layer each comprise a substantially waterproof material.

18. The apparatus of claim 1, wherein the single layer of dielectric spacer comprises a layer of foam.

19. The apparatus of claim 1, wherein the two conductive foil sheets each comprise an aluminum foil.

20. The apparatus of claim 1, wherein the signal indicating that a pet is positioned on the pet pressure mat is only generated after the two conductive foil sheets contact each other for at least a pre-defined period of time.
